(19) United States
(12) Patent Application Publication
(10) Pub. No.: US 2005/0002106 A1
(43) Pub. Date: Jan. 6, 2005

(54) Method of manufacturing micro lens, micro lens, optical device, optical transmission device, head for laser printer, and laser printer

(75) Inventor: Hironori Hasei, Okaya-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/834,944

(22) Filed: Apr. 30, 2004

(30) Foreign Application Priority Data
May 16, 2003 (JP) 2003-138798

(51) Int. Cl. B29D 11/00; G02B 3/00; G02B 27/10

(52) U.S. Cl. 359/620; 264/1.32

(57) ABSTRACT

The invention provides a method of manufacturing a micro lens, a micro lens, an optical device having the micro lens, an optical transmission device, a head for a laser printer, and a laser printer, by which excellent lens characteristics, such as a condensing function, can be obtained by optionally controlling the shape thereof. The micro lens is formed on the upper surface of a foundation member formed on a base. The upper surface of the foundation member is subjected to lyophobic processing. The micro lens is formed by ejecting lens material in a plurality of dots by a droplet ejecting method.

### BACKGROUND OF THE INVENTION

1. Field of Invention

The present invention relates to a method of manufacturing a micro lens, a micro lens obtained by the method, an optical device having the micro lens, an optical transmission device, a head for a laser printer, and a laser printer.

2. Description of Related Art

Related art optical devices have a plurality of minute lenses, referred to as micro lenses. These optical devices include, for example, light-emitting devices having lasers, optical interconnections formed of optical fibers, and charge coupled devices having a condensing lens to collect incident light.

The micro lenses constituting such optical devices can be manufactured by a molding method using a mold or a photolithography method (for example, as disclosed in Japanese Unexamined Patent Application Publication No. 2000-35504).

The related art also includes a method of forming micro lenses having a minute pattern using the droplet ejecting method used in printers (for example, as disclosed in Japanese Unexamined Patent Application Publication No. 2000-280367).

### SUMMARY OF THE INVENTION

However, in the molding method using the mold or the photolithography method, since the mold or a complicated manufacturing process is needed in order to form the micro lens, problems arise in that the cost thereof becomes high and it is difficult to form a micro lens having a predetermined shape at a certain location.

In addition, in the case of employing the droplet ejecting method, it is easy to form the micro lens at a certain location, but it is difficult to control the shape thereof to a desired shape.

The present invention addresses or solves the above and/or other problems, and provides a method of manufacturing a micro lens, a micro lens, an optical device having the micro lens, an optical transmission device, a head for a laser printer, and a laser printer in which excellent optical characteristics, such as a condensing function, can be obtained by optionally controlling the shape of the microlens.

In order to address or accomplish the above, a method of manufacturing a micro lens according to the present invention includes: forming a foundation member on a base; subjecting the upper surface of the foundation member to lyophobic processing; and ejecting lens material on the lyophobic-processed foundation member in a plurality of dots by a droplet ejecting method to form the micro lens on the foundation member.

According to the method of manufacturing the micro lens, since the micro lens is formed on the foundation member, the size or the shape of the upper surface of the foundation member is suitably controlled. As a result, the size or the shape of the obtained micro lens can be suitably controlled. In addition, since the upper surface of the foundation member is subjected to the lyophobic processing, the contact angle of the ejected lens material with respect to the upper surface of the foundation member can become large, and thus the amount of the lens material applied to the upper surface of the foundation member can become increased. In addition, since the lens material is ejected in a plurality of the dots under the state that the amount of the lens material applied to the upper surface of the foundation member is increased, the size or the shape of the obtained micro lens is favorably controlled by suitably adjusting the number of the dots, and thus the micro lens having a shape close to, for example, a sphere can be formed.

In addition, in the method of manufacturing the micro lens, it is preferable that, in the lyophobic-processing step, when the lens material is positioned with respect to the plane formed of the foundation member forming material, the lyophobic process is performed so that the lyophobic properties, that is, the contact angle of the lens material being 20° or more, are exhibited.

Thereby, since the contact angle of the ejected lens material with respect to the upper surface of the foundation member becomes surely large, the amount of the lens material applied to the upper surface of the foundation member can be increased more.

In addition, in the method of manufacturing the micro lens, it is preferable that, in the step of forming the foundation member, the shape of the upper surface of the foundation member be circular, elliptical, or polygonal.

According to the configuration, the micro lens having a shape close to a sphere can be formed, and thus the optical characteristics, such as a condensing function, can be controlled by suitably adjusting the curvature.

Moreover, in the method of manufacturing the micro lens, it is preferable that, when ejecting the lens material by the droplet ejecting method, the number of the ejected dots be determined so that the curvature of the upper surface of the formed micro lens becomes a predetermined curvature.

According to the configuration, since the curvature of the surface side becomes a predetermined curvature, the micro lens having desired optical characteristics can be formed by allowing the light from the upper surface to be transmitted.

The micro lens according to the present invention is provided by the above method. For example, the micro lens is provided such that the micro lens is formed on the upper surface of a foundation member formed on a base, the upper surface of the foundation member is subjected to lyophobic processing, and the micro lens is formed by ejecting a lens material in a plurality of dots by a droplet ejecting method.

According to the micro lens, since the micro lens is formed on the foundation member, the size or the shape thereof can be favorably controlled by suitably controlling the size or the shape of the surface of the foundation member. In addition, since the surface of the foundation member is subjected to the lyophobic processing, the contact angle of the ejected lens material with respect to the upper surface of the foundation member becomes large, and thus the amount of the lens material applied to the upper surface of the foundation member can be increased. In addition, the size or the shape of the obtained micro lens is favorably controlled by suitably adjusting the number of the dots of the ejected lens material, and thus the micro lens having a shape close to, for example, a sphere can be formed.

In addition, in the micro lens, it is preferable that the shape of the upper surface of the foundation member be circular, elliptical, or polygonal.

According to the configuration, the shape thereof become close to the sphere, and thus the optical characteristics, such as a condensing function, can be favorably controlled by suitably adjusting the curvature.

In addition, in the micro lens, it is preferable that the maximum outer diameter of the transverse section of the micro lens parallel to the upper surface of the foundation member be larger than the outer diameter of the upper surface of the foundation member.

According to the configuration, since the micro lens has the outer diameter of the transverse section larger than the outer diameter of the upper surface of the foundation member, the micro lens has, for example, a shape close to the sphere, and thus the optical characteristics, such as a condensing function, can be favorably controlled by suitably adjusting the curvature.

In addition, in the micro lens, it is preferable that the foundation member have transmissivity.

According to the configuration, in case of positioning the light emitting source on the side of the foundation member, the light from the light emitting source can be favorably emitted from the upper surface of the micro lens, and thus the condensing function can be exhibited by the curvature of the upper surface.

An optical device according to the present invention includes a surface light emitting laser, and the micro lens obtained by the above-mentioned manufacturing method. The micro lens is positioned on an emitting side of the surface light emitting laser.

According to the optical device, since the micro lens the size or the shape of which can be favorably controlled is positioned on the emitting side of the surface light emitting laser, the condensing of the emitted light from the light emitting laser can be favorably performed by the micro lens, and thus the excellent light emitting characteristics (the optical characteristics) can be obtained.

An optical transmission device according to the present invention includes the above-mentioned optical device, a light receiving element, and an optical transmission device to transmit the light emitted from the optical device to the light receiving element.

According to the optical transmission device, since it includes the optical device having the excellent light emitting characteristics (the optical characteristics) as mentioned above, an optical transmission device that has excellent transmitting characteristics can be obtained.

A head for the laser printer according to the present invention includes the above-mentioned optical device.

According to the head for the laser printer, since it includes the optical device having the excellent light emitting characteristics (the optical characteristics) as mentioned above, a head for the laser printer that has excellent drawing characteristics can be obtained.

A laser printer according to the present invention includes the above-mentioned head for the laser printer.

According to the laser printer, since it includes the head for the laser printer having the excellent drawing characteristics as mentioned above, a laser printer that has excellent drawing characteristics can be obtained.

### BRIEF DESCRIPTION OF THE DRAWINGS

FIGS. 1a to 1e are schematics that show a process of manufacturing a micro lens according to an exemplary embodiment of the present invention;

FIGS. 2a and 2b are schematics of an inkjet head;

FIGS. 3a and 3b are schematics that show a process of manufacturing the micro lens according to the present invention;

FIGS. 4a to 4c are schematics that show the micro lens according to the present invention;

FIGS. 5a to 5c are schematics that show a condensing function of the micro lens;

FIG. 6 is a schematic that illustrates a contact angle of lens material according to lyophobic processing; and

FIG. 7 is a schematic of a head for a laser printer according to the present invention.

### DETAILED DESCRIPTION OF PREFERRED EMBODIMENTS

Exemplary embodiments of the present invention are explained in detail below.

First, a method of manufacturing a micro lens according to the present invention is explained. The method of manufacturing the micro lens according to the present invention includes: forming a foundation member on a base, subjecting the upper surface of the foundation member to lyophobic processing; and ejecting lens material on the lyophobic-processed foundation member in a plurality of dots by a droplet ejecting method to form the micro lens on the foundation member.

Here, in the present invention, “base” means a substance having a surface on which the foundation member can be formed, and, in particular, refers to a glass substrate or a semiconductor substrate, or a material having various functional thin films or functional elements formed thereon. In addition, the surface on which the foundation member can be formed may be a curved surface or a flat surface; that is, the shape of the base is not specially limited, and may take various shapes.

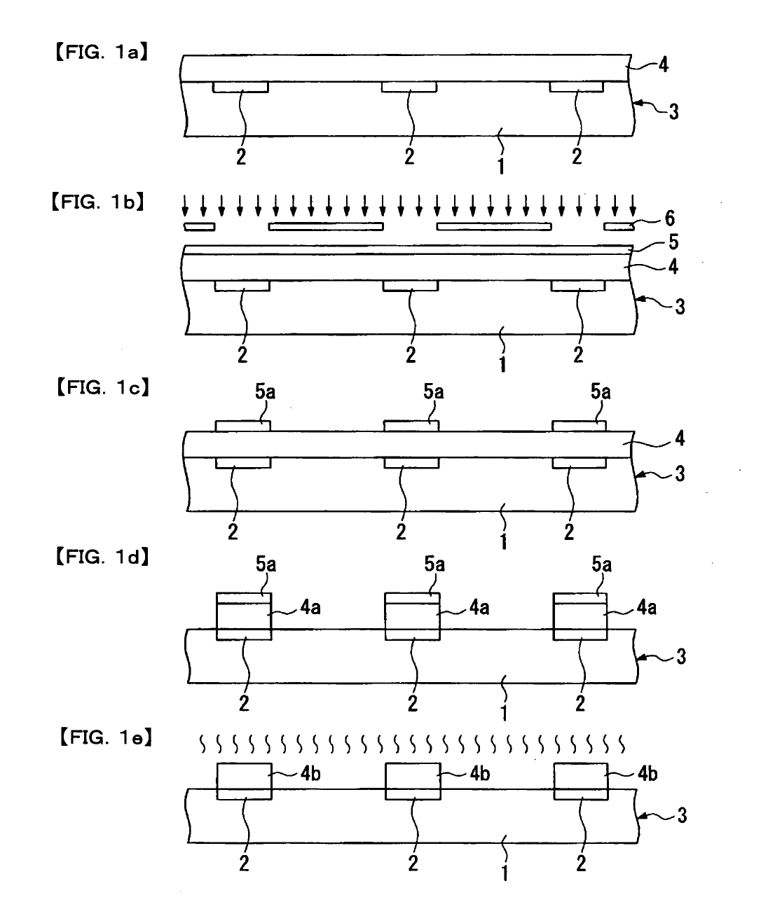

In the present invention, as shown in FIG. 1a, for example, by using a GaAs substrate 1, the GaAs substrate 1 having a plurality of surface light emitting lasers 2 formed thereon is prepared as a base 3. In addition, the upper surface of the base 3, that is, the surface of the emitting side of the surface light emitting lasers 2 is provided with material to form the foundation member to form the foundation member material layer 4. In addition, the surface light emitting lasers 2 each have an insulating layer (not shown) composed of polyimide resin at the periphery of the emitting port thereof formed thereon. Here, as the material to form the foundation member, a material having transmissivity, that is, a material that hardly absorbs the wavelength region of the emitted light from the surface light emitting laser 2 but that substantially transmits the emitted light, is preferable. For example, although polyimide resin, acrylic resin, epoxy resin, or fluorine resin is preferably used, in particular, polyimide resin is most preferable.

In the present exemplary embodiment, polyimide resin is used as the material to form the foundation member. In addition, a precursor of this polyimide resin is applied on the base 3 and then the base 3 is heated at a temperature of about 150° C., thereby forming the foundation member material layer 4, as shown in FIG. 1a. In addition, in this step, the foundation member material layer 4 is not sufficiently cured so that it is just hard enough to maintain its shape.

When the foundation member material layer 4 composed of polyimide resin is formed, a resist layer 5 is formed on the foundation member material layer 4, as shown in FIG. 1b. In addition, a mask 6 having a predetermined pattern formed thereon is exposed by using the resist layer 5, and is developed, thereby forming a resist pattern 5a, as shown in FIG. 1c.

Next, by using the resist pattern 5a as the mask, the foundation member material layer 4 is patterned by a wet etching method using alkali solution. Thereby, as shown in FIG. 1d, the foundation member pattern 4a is formed on the base 3. Here, in the formed foundation member pattern 4a, it is preferable that the shape of the upper surface thereof be circular, elliptical, or polygonal in order to form the micro lens thereon. In the present exemplary embodiment, the shape of the upper surface is circular. In addition, the foundation member material pattern is formed so that the central location of the circular upper surface is positioned immediately above the emitting port (not shown) of the surface light emitting laser 2 formed on the base 3.

Then, as shown in FIG. 1e, the resist pattern 5a is removed and heat treatment is performed at about 350° C. to sufficiently cure the foundation member pattern 4a, thereby forming the foundation member 4b.

Next, the upper surface of the foundation member 4b is subjected to lyophobic processing. As the lyophobic processing, for example, a plasma processing method (CF₄ plasma processing method) using tetrafluoromethane as the processing gas in air is suitably employed. The conditions of the CF₄ plasma process are as follows: the plasma power is 50 to 1000 kW, the flow rate of tetrafluoromethane (CF₄) gas is 50 to 100 ml/min, the carrying rate of the base 3 with respect to the plasma discharge electrode is 0.5 to 1020 mm/sec, and the temperature of the base is 70 to 90° C.

In addition, the processing gas is not limited to tetrafluoromethane (CF₄) gas, and another fluorocarbon gas can be used. By performing the lyophobic processing, fluorine radicals are introduced into the resin on the upper surface of the foundation member 4b, thereby endowing it with high lyophobic properties.

Here, it is preferable that such lyophobic processing be performed so as to exhibit the lyophobic properties such that the contact angle of the lens material being 20° or more, when the below-mentioned lens material is positioned with respect to the plane formed of the material for forming the foundation member 4b.

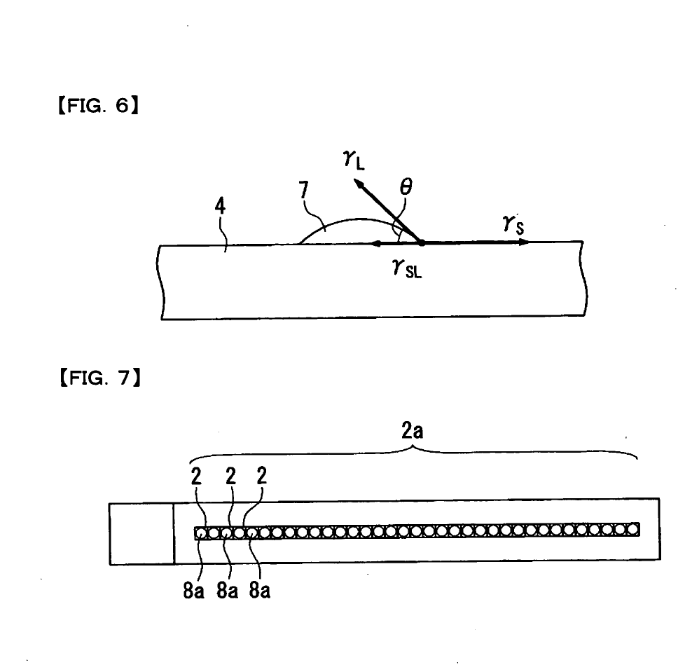

In other words, as shown in FIG. 6, the foundation member material layer 4 is formed by the material to form the foundation member 4b (in this exemplary embodiment, polyimide resin), and the surface thereof becomes flat. In addition, the lyophobic processing on this surface is performed. Next, the lens material 7 is positioned on this surface by the droplet ejecting method.

As a result, the lens material 7 forms droplets having a shape depending on the wettability with respect to the surface of the foundation member material layer 4. At this time, when the surface tension of the foundation member material layer 4 is γ_{S}, the surface tension of the lens material 7 is γ_{L}, the interface tension between the foundation member material layer 4 and the lens material 7 is γ_{SL}, and the contact angle of the lens material 7 with respect to the foundation member material layer 4 is θ, the following equation holds for γ_{S}, γ_{L}, γ_{SL}, and θ.
γ_{S}=γ_{SL}+γ_{L}·cos θ

As mentioned below, the lens material 7 to form the micro lens has a curvature limited by the contact angle 0 determined by the above-mentioned equation. In other words, the curvature of the lens that is obtained after curing the lens material 7 is one of the factors determining the shape of the final micro lens. Accordingly, in the present invention, since the interface tension γ_{SL} between the foundation member material layer 4 and the lens material 7 is increased by the lyophobic processing so that the shape of the obtained micro lens becomes similar to a spherical shape, it is preferable that the contact angle θ be large, that is, 20° or more.

Like this, the lyophobic processing according to the condition that the contact angle θ shown in FIG. 6 becomes 20° or more is performed on the upper surface of the foundation member 4b, and thus the contact angle θ′ of the lens material 7, which is ejected and positioned on the upper surface of the foundation member 4b, with respect to the upper surface of the foundation member 4b, is surely increased. Accordingly, the amount of lens material applied to the upper surface of the foundation member can be increased further, and then it is easy to control the shape thereof by the ejected amount (the ejected dot amount).

When the lyophobic processing on the upper surface of the foundation member 4b is performed, the lens material 7 is ejected onto the foundation member 4b in a plurality of dots by the droplet ejecting method. Here, as the droplet ejecting method, a dispenser method or an inkjet method can be employed. The dispenser method is a general method to eject the droplets, and is the method that is useful in ejecting the droplets over a relatively wide area. The inkjet method is a method for ejecting the droplet using an inkjet head. In addition, since the inkjet method can control the location of ejecting the droplets on the micrometer-order and can control the ejected amount of the droplets on the order of picoliters, this method is preferable for manufacturing minute lenses (micro lenses).

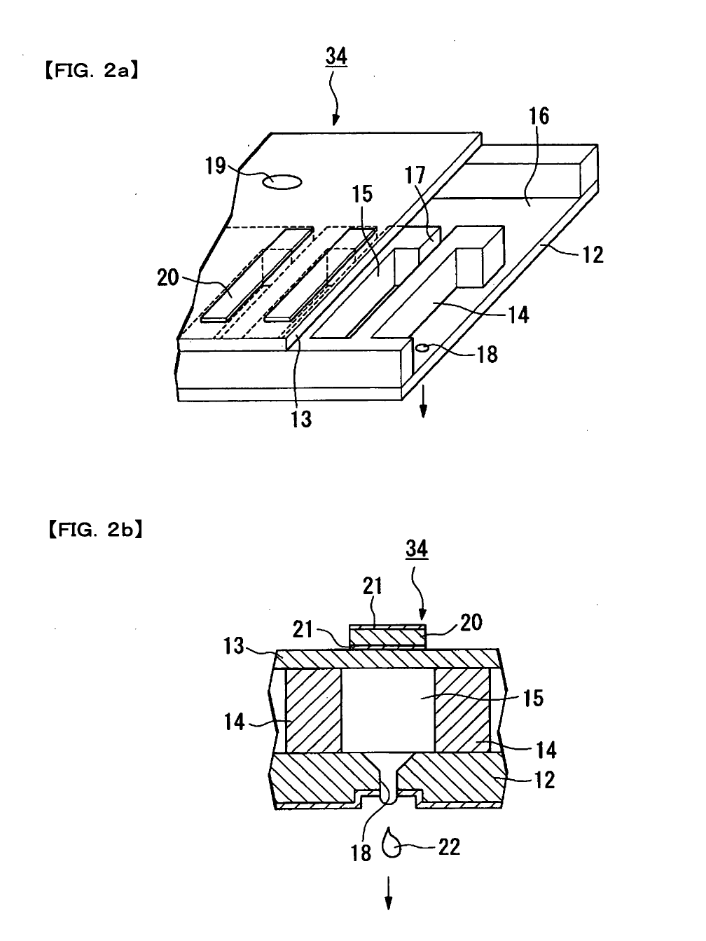

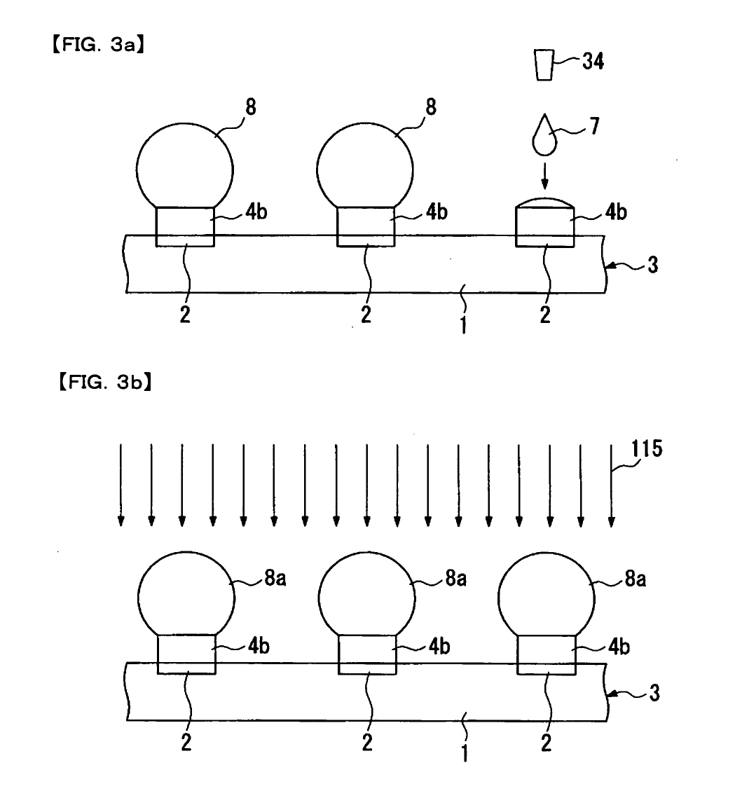

In the present exemplary embodiment, the inkjet method is used as the droplet ejecting method. The inkjet method uses an inkjet head 34 which has a stainless steel nozzle plate 12 and a vibration plate 13 adhered to each other by means of a partition member (the reservoir plate) 14, as shown in FIG. 2a. Between the nozzle plate 12 and the vibration plate 13, a plurality of cavities 15 and a reservoir 16 are formed by the partition member 14, and the cavities 15 and the reservoir 16 are connected to each other through a flow path 17.

Each of the cavities 15 and the reservoir 16 are filled with liquid substance to be ejected (lens material), and the flow path 17 therebetween functions as a supplying port to supply the liquid substance from the reservoir 16 to the cavity 15. In addition, the nozzle plate 12 has a plurality of hole-shaped nozzles 18 arranged in all directions for ejecting the liquid substance from the cavity 15 formed thereon. On the other hand, the vibration plate 13 has a hole 19 formed in the reservoir 16 formed thereon, and the hole 19 is connected with the liquid substance tank (not shown) through a tube (not shown).

In addition, the surface facing the cavity 15 of the vibration plate 13 and the opposite surface thereof are adhered with a piezoelectric element 20, as shown in FIG. 2b. Since the piezoelectric element 20 is sandwiched between a pair of electrodes 21, 21 and is made to flex and protrude outward by supplying a current, it functions as the ejecting device in the present invention.

Under this configuration, the vibration plate 13 adhered with the piezoelectric element 20 is integral with the piezoelectric element 20 and they are flexed outward, thereby increasing the capacity of the cavity 15. As a result, in the case where the cavity 15 is connected with the reservoir 16 and the reservoir 16 is filled with the liquid substance, the liquid substance corresponding to the increased capacity is introduced into the cavity 15 through the flow path 17 from the reservoir 16.

In addition, when the current supplied to the piezoelectric element 20 is stopped in this state, the piezoelectric element 20 and the vibration plate 13 return to their original shapes. Accordingly, since the cavity 15 also returns to its original capacity, the pressure of the liquid substance in the cavity 15 is increased and the droplets 22 of the liquid substance are ejected from the nozzles 18.

In addition, as the ejecting device of the inkjet head, a substance other than the electromechanical converting substance using the above-mentioned piezoelectric element 20 can be used, and a method using an electro-thermal converting substance using an energy generating element, a subsequent method such as charging control type or press vibration type, an electrostatic absorbing method, or a method for irradiating electromagnetic waves, such as laser light to generate heat and ejecting the liquid substance by the heating, can be employed.

In addition, as the ejected lens material 7, that is, the lens material 7 that becomes the micro lens, a light-transmitting resin is used. Concretely, a thermosetting or thermoplastic resin, such as acrylic resin, such as polymethylmethacrylate, polyhydroxy-ethylmethacrylate, or polycyclohexylmethacrylate; aryl resin, such as polydiethyleneglycol-bisarylcarbonate, or polycarbonate; methacrylate resin; polyulethane resin; polyester resin; polyvinylchloride resin; polyvinylacetate resin; cellulose resin; poleyamide resin; fluorine resin; polypropylene resin; polystyrene resin; or a combination thereof may be used.

In addition, in the present invention, as the light-transmitting resin, a non-solvent system is preferably used. The light-transmitting resin of the non-solvent system dissolves the light-transmitting resin by using an organic solvent and liquefies the light-transmitting resin by diluting it with a monomer without the liquid substance so as to eject the light-transmitting resin from the inkjet head 34. In addition, by mixing a photopolymerization initiator, such as biimidazole compound, the light-transmitting resin of the non-solvent system can be used as a radiation-curing type of resin. That is, by mixing the photopolymerization initiator, radiation hardening properties are supplied to the light-transmitting resin. Here, radiation is the general name for visible rays, ultraviolet rays, farultraviolet rays, x-rays, or electron beams, etc., and, in particular, ultraviolet rays are generally used.

As shown in FIG. 3a, such lens material 7 is ejected on the foundation member 4b in a plurality of dots, for example, 30 dots, by the inkjet head 34 composed of the above-mentioned components, thereby forming the micro lens precursor 8 on the foundation member 4b. Accordingly, by ejecting the lens material 7 by the inkjet method, the lens material 7 can be precisely positioned in substantially the central portion on the foundation member 4b. In addition, as mentioned above, by subjecting the upper surface of the foundation member 4b to lyophobic processing, it is difficult for the droplets of the ejected lens material 7 to spread on the upper surface of the foundation member 4b, and, accordingly, the lens material 7 positioned on the foundation member 4b is maintained on the foundation member 4b in a stable state, without dropping off the foundation member 4b. In addition, by intermittently ejecting lens material in several dots (in this example, 30 dots), the transverse section (the horizontal surface parallel to the upper surface of the foundation member 4b) of the micro lens precursor 8 composed of the ejected lens material 7 becomes larger than that at the upper surface of the foundation member 4b.

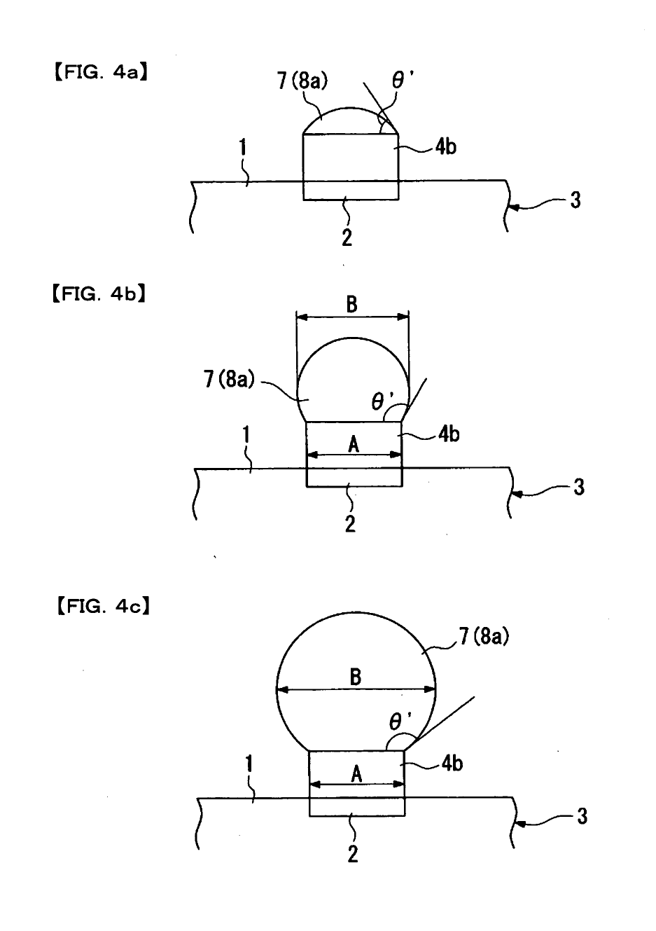

In other words, when initiating ejection of the lens material 7, since the amount of lens material 7 ejected is small, the amount of lens material is generally not increased to such an amount that the lens material is spread on the entire upper surface of the foundation member 4b, and thus the contact angle θ′ with respect to the upper surface of the foundation member 4b becomes an acute angle, as shown in FIG. 4a.

From this state, if the lens material 7 is continuously ejected, the lens material 7 ejected later has high adherence to the lens material 7 ejected previously, and thus the lens material is integral without being dropped off, as shown in FIG. 4b. As a result, the volume of the integral lens material 7 is increased, thereby increasing the contact angle θ′ with respect to the upper surface of the foundation member 4b to exceed a right angle.

When the lens material 7 is continuously ejected in this state, the amount of lens material is not large in every dot because the lens material is ejected by the inkjet method, and thus the overall balance on the foundation member 4b is maintained. As a result, the contact angle θ′ becomes a large obtuse angle, as shown in FIG. 4c, thus having a shape similar to a sphere.

Like this, by subjecting the upper surface of the foundation member 4b to lyophobic processing and positioning the lens material 7 in a plurality of dots by the inkjet method (droplet ejecting method), which can precisely jet the lens material at the ejected location by a predetermined amount on the lyophobic-processed surface, the micro lens precursor 8 is made according to the desired shape in which the contact angle θ′ is varied from a relatively small acute angle to a large obtuse angle. That is, the micro lens having a desired shape can be formed by determining the shape in advance in accordance with the shape of the micro lens formed of the ejected number of dots.

When forming the micro lens precursor 8 having the desired shape (a shape close to spherical, as shown in FIG. 4c in this exemplary embodiment), the micro lens precursor 8 is cured as shown in FIG. 3b, thereby forming the micro lens 8a.

In the curing process of the micro lens precursor 8, the substance subjected to radiation hardening without (as mentioned above) adding the organic solvent is provided as the lens material 7, and thus particularly the processing method by irradiation of ultraviolet rays (wavelength λ=365 nm) is preferably used.

In addition, after the curing process by the irradiation of ultraviolet rays, it is preferable that heat treatment be performed at about 100+ C. for 1 hour. By performing the heat treatment, although hardening ununiformity is generated in the curing process by irradiating ultraviolet rays, the hardening ununiformity is decreased and thus a substantially uniform hardness can be obtained as a whole.

Thereby, when forming the micro lens 8a, the base 3 is cut, if necessary, and the desired shape is made by forming the array shape or by performing separation.

In addition, an optical device of an embodiment of the present invention can be obtained from the micro lens 8a manufactured by the above-mentioned method and the surface light emitting laser 2 previously formed on the base 3.

In the method of manufacturing the micro lens 8a, since the micro lens 8a is formed on the foundation member 4b, the size or the shape of the obtained the micro lens 8a can be suitably accomplished by suitably forming the size or the shape of the upper surface of the foundation member 4b. Further, since the upper surface of the foundation member 4b is lyophobic processed, the contact angle θ′ of the ejected lens material 7 with respect to the surface of the foundation member 4b can become large, thereby increasing the amount of the lens material 7 applied to the upper surface of the foundation member 4b. In addition, in the state that the amount of the lens material 7 applied to the upper surface of the foundation member 4b is large, the lens material 7 is ejected in a plurality of dots, and thus the shape or the size of the obtained micro lens 8a can be controlled by suitably adjusting the number of the dots.

In other words, the shape of the micro lens 8a can become various shapes shown in FIGS. 4a to 4c, that is, a flat shape (FIG. 4a), a shape close to the semi-sphere in the side (FIG. 4b)), and a shape close to a sphere in the side (FIG. 4c)). Accordingly, in this exemplary embodiment, the emitted light from the surface light emitting laser 2 formed on the base 3 transmits the foundation member 4b to be emitted from the opposite side of the foundation member 4b, that is, the upper surface of the micro lens 8a, as shown in FIGS. 4a to 4c, the curvature of the upper surface of the micro lens 8a is suitably made, and thus the condensing function of the micro lens 8a is adjusted as set previously.

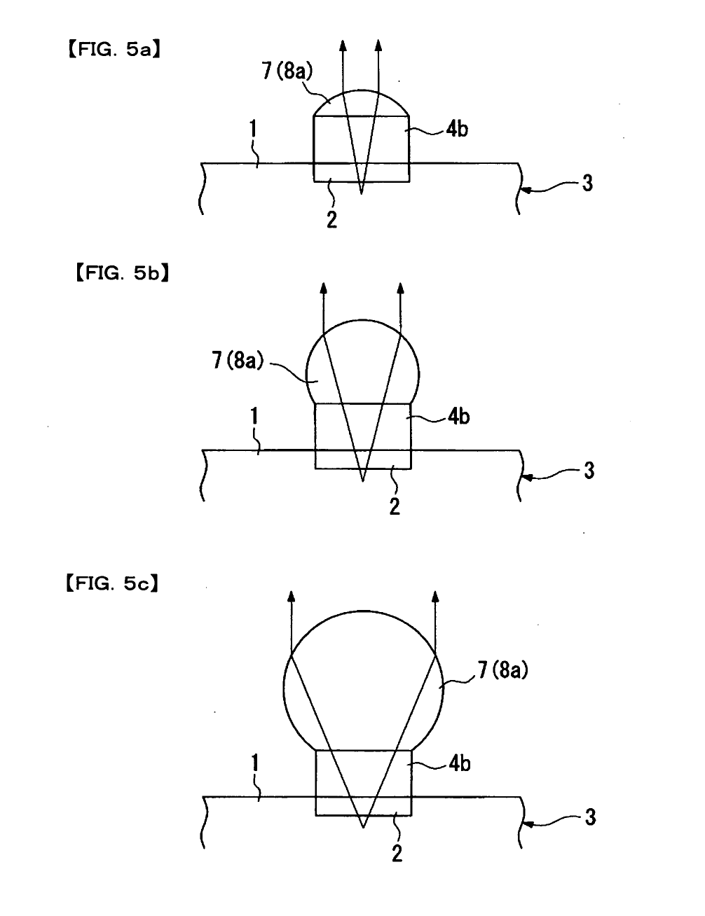

Accordingly, in case that the emitted light from the surface light emitting laser 2 transmits the foundation member 4b to be incident to the micro lens 8a as the irradiated light, the micro lens is formed so that the shape of the micro lens 8a, that is, the curvature of the upper surface of the micro lens 8a becomes a predetermined curvature in accordance with the irradiation degree of the irradiated light, and thus the irradiated light (the emitted light) from the surface light emitting laser 2 can be preferably focused to the micro lens 8a, as shown in FIGS. 5a to 5c.

In addition, on the contrary, in case that the light from the light emitting source such as the surface light emitting laser 2 has straightness without radiation, the light transmits the micro lens 8a, and then the permeated light can have radiation.

In addition, particularly, as shown in FIGS. 4b and 4c, the micro lens 8a is formed so the outer diameter B of the maximum transverse section among the transverse sections parallel to the upper surface becomes large than the outer diameter A of the upper surface of the foundation member 4b, and thus the micro lens 8a is close to the sphere compared to that shown in FIG. 4a. Accordingly, the curvature of the upper surface can become relatively small, and the condensing function can be increased more.

In addition, in the optical device comprised of the micro lens 8a manufactured as mentioned above and the surface light emitting laser 2 formed on the base 3, since the micro lens 8a the size or the shape of which is preferably controlled as mentioned above is positioned on the emitting side of the surface light emitting laser 2, the condensing of the emitted light from the surface light emitting laser 2 can be preferably performed by the micro lens 8a, and thus the superior light emitting characteristics (the optical characteristics) can be obtained.

In addition, in the above-mentioned exemplary embodiment, the foundation member material layer 4 is formed on the base 3 to form the foundation member 4b from the foundation member material layer 4, but the present invention is not limited thereto. For example, in case that surface layer of the base 3 is formed of permeable material, the foundation member may be directly formed on the surface layer.

In addition, the method of forming the foundation member 4b is not limited to the above-mentioned photolithography method, and another method, for example, a selective growth method or a transferring method, may be employed.

In addition, in the shape of the surface of the foundation member 4b, various shapes, such as a triangle or a quadrangle, may be employed in accordance with the characteristics required for the micro lens to be formed. Further, in the shape of the foundation member 4b itself, various shapes, such as a taper or a reverse taper, may be employed.

In addition, in the above-mentioned exemplary embodiment, the micro lens 8a formed on the foundation member 4b is used as the lens, but the present invention is not limited to thereto. The micro lens is separated or stripped from the foundation member 4b by a suitable method, and the micro lens 8a alone may be used as the optical component. In this case, the foundation member 4b used in the manufacture does not need to have transmissivity.

In the present invention, in addition to the optical device having the surface light emitting laser 2 and the micro lens 8a, a light transmission means having an optical fiber or a optical waveguide to transmit the emitted light from the optical device and a light receiving device to receive the light transmitted by the optical transmission device are provided, it can function as the optical transmission device.

In such optical transmission device, since it has the optical device having superior light emitting characteristics (the optical characteristics) as mentioned above, the optical transmission device has superior transmitting characteristics.

In addition, the head for the laser printer according to the present invention includes the above-mentioned optical device. In other words, the optical device used in the head for the laser printer includes a surface light emitting laser array 2a including a plurality of surface light emitting lasers 2 that are positioned in a straight line, and a micro lens 8a is positioned on each of the surface light emitting lasers 2 forming the surface light emitting laser array 2a, as shown in FIG. 7. Further, a driving element (not shown), such as a TFT, is provided in the surface light emitting laser 2, and a temperature compensating circuit (not shown) is provided in the head for the laser printer.

Further, the laser printer according to the present invention can be manufactured by equipping the head for the laser printer having the above-mentioned structure.

Since the head for the laser printer is equipped with the optical device having superior light emitting characteristics (the optical characteristics) as mentioned above, the head for the laser printer having superior drawing characteristics can be obtained.

In addition, since the laser printer having this head for the laser printer is equipped with the head for the laser printer having superior drawing characteristics as mentioned above, the laser printer has excellent patterning characteristics.

In addition, the micro lens according to the present invention can be applied to various optical devices other than the above-mentioned optical device, and, for example, the optical component provided in a light receiving surface of a charge coupled device (CCD) or a light coupling portion of the optical fiber, can be used.

1. A method of manufacturing a micro lens, comprising:
forming a foundation member on a base;
subjecting an upper surface of the foundation member to lyophobic processing; and
ejecting a lens material on the lyophobic-processed foundation member in a plurality of dots by a droplet ejecting method to form the micro lens on the foundation member.

2. The method of manufacturing a micro lens according to claim 1,
the subjecting including, when the lens material is positioned with respect to the plane formed of the foundation member forming material, performing the lyophobic process so that the lyophobic properties, including the contact angle of the lens material being at least 20°, are exhibited.

3. The method of manufacturing a micro lens according to claim 1,
the forming including forming the foundation member such that a shape of the upper surface of the foundation member is at least one of circular, elliptical, and polygonal.

4. The method of manufacturing a micro lens according to claim 1,
further including, when ejecting the lens material by the droplet ejecting method, determining the number of the ejected dots so that the curvature of the upper surface of the formed micro lens becomes a predetermined curvature.

5. A micro lens formed by the method according to claim 1.

6. The micro lens according to claim 5,
a shape of the upper surface of the foundation member being at least one of circular, elliptical, and polygonal.

7. The micro lens according to claim 5,
a maximum outer diameter of a transverse section of the micro lens parallel to the upper surface of the foundation member being larger than an outer diameter of the upper surface of the foundation member.

8. The micro lens according to claim 5,
the foundation member having transmissivity.

9. An optical device, comprising:
a surface light emitting laser; and
the micro lens according to claim 5, the micro lens being positioned on an emitting side of the surface light emitting laser.

10. An optical transmission device, comprising:
the optical device according to claim 9;
a light receiving element; and
an optical transmission device to transmit light emitted from the optical device to the light receiving element.

11. A head for a laser printer, comprising:
the optical device according to claim 9.

12. A laser printer, comprising:
the head for a laser printer according to claim 11.
